(19) United States
(12) Patent Application Publication
(10) Pub. No.: US 2013/0184084 A1
(43) Pub. Date: Jul. 18, 2013

(54) STEAMPUNK FLOGGER HAVING INTERCHANGABLE HANDLES AND FLOGGER HEADS

(71) Applicants: Stephen J. Roe, Madison, WI (US); Amanda J. Gilderson, Edgerton, WI (US)

(72) Inventors: Stephen J. Roe, Madison, WI (US); Amanda J. Gilderson, Edgerton, WI (US)

(21) Appl. No.: 13/550,596

(22) Filed: Jul. 16, 2012

Related U.S. Application Data
(63) Continuation-in-part of application No. 29/397,481, filed on Jul. 15, 2011.
Application No. 29/397,481 is a continuation-in-part of application No. 29/397,483, filed on Jul. 15, 2011.

(51) Int. Cl. B68B 11/00

(52) U.S. Cl. CPC B68B 11/00
USPC 463/47.2

(57) ABSTRACT

A flogger system includes a flogger handle and any number of detachable flogger heads. The flogger handle has a free end and a head end. The head end includes a connector portion. The flogger head has a falls end and a handle end. The falls end of the flogger head includes at least one fall, which can be made using any number of industrial materials, including metal materials, plastic materials, leather, rubber, synthetic fibers and natural fibers. The handle end of the flogger head includes a complementary connector portion that is complementary to the connector portion of the head end of the flogger handle. The connector and complementary connector portions are detachably securely connectable, and allow any of the detachable flogger heads to be attached to the flogger handle. When the connector and complementary connector portions are connected together, they securely attach the flogger head to the flogger handle.

### BACKGROUND OF THE INVENTION

This is a continuation-in-part of pending U.S. patent application Ser. Nos. 29/397,481 and 29/397,483, each filed Jul. 15, 2011, the entirety of each of these applications hereby incorporated herein by reference.

1. Field of Invention

The invention relates to costume and novelty props. In particular, this invention relates to a costume or novelty prop for live action roll playing activities and adult fetish activities that includes at least one handle and a plurality of interchangeable heads.

2. Description of Related Art

Live action roll playing activities are becoming increasingly popular. These activities include, but are not limited to live action roll playing games and conventions. Live action roll playing activities are similar to historical re-enactment activities, such as renaissance faires, Civil War and Revolutionary War re-enactments and the like, except that live action roll playing activities are typically set in fantasy or alternate-history universes. Participants in live action roll playing activities typically create characters with elaborate personal histories and portray those characters during the live action roll playing activities. Portraying the character typically includes creating an appropriate costume, including costume accessories, jewelry and the like and wearing that costume during the live action roll playing activities. One of the fundamental ideas in live action roll playing activities is that the costumes and any accessories should be as functional as possible.

Steampunk is one such genre of live action roll playing activities. Steampunk is set in the Victorian era in an alternate history/universe where the aether that was hypothesized to be the medium through which light travels actually exists and steam-driven mechanical devices and aether-powered devices take the place of many modern electronically-operated devices. Steampunk costumes and props typically have an industrial theme, and use iron, copper and brass sheet metal, piping and fittings whenever possible. The steampunk genre envisions great airships, ocean-going vessels and even space-traveling vessels, but maintains the Victorian-era concepts of corporal punishment, such as the use of floggers to maintain discipline within the crew of these vessels. Thus, Steampunk live action roll playing costumes often include costume or novelty floggers, which many participants require to be as functional as possible.

Similarly, participants in adult fetish activities also typically create one or more appropriate fetish costumes, with each fetish costume including a variety of accessories, jewelry and the like. As in live action roll playing activities, participants in adult fetish activities wear one or more of these fetish costumes during the adult fetish activities. Like steampunk, adult fetish activities also make use of Victorian-era concepts of corporal punishment, such as the use of floggers. Thus, adult fetish costumes also often include costume or novelty floggers, which many adult fetish participants also require to be as functional as possible.

While a variety of manufacturers and artisan craftsmen make and sell floggers as costume props and novelties, their typical floggers are made with leather or rubber falls and wooden, leather, plastic or shiny chrome-plated metal handles. These typical floggers may incorporate any of these materials as the handle, and rubber or any one of a wide variety of different types of leather as the falls, but they invariably have the falls permanently attached to the handle materials. Thus, if a participant in the above-outlined activities wishes to have different falls in a variety of different materials, he or she is obligated to by a variety of complete floggers, each having its falls made of one of the variety of desired materials.

### SUMMARY OF THE INVENTION

Both steampunk and adult fetish activity participants typically have a number of different costumes. and typically add and retire different costumes over time. It is also desirable to have a variety of different props that can be used with each costume. Thus, a participant may end up with a large number of different props, costume accessories and/or novelties. Thus, a participant may end up with a large number of different props, costume accessories and/or novelties. It would be beneficial if a participant could change the falls of a flogger without also having to change the handle, or vice-versa

This invention provides a flogger system having at least one handle and at least one detachable, interchangeable flogger head.

This invention separately provides a flogger system having at least one flogger head made using an industrial material as the flogger falls.

This invention further provides a flogger system having at least one detachable and interchangeable flogger head made using at least one of ball chain, wire rope, cable ties, sheet metal, screen window spline, sash chain, and/or hobby chain as the industrial material flogger falls.

This invention separately provides a flogger system having at least one detachable and interchangeable flogger head made using natural or synthetic fiber material as the flogger falls.

This invention further provides a flogger system having at least one detachable and interchangeable flogger head made using at least one of manila, hemp, sisal, palm frond, silk, nylon, polyester, polypropylene and/or polyethylene as the fiber material flogger falls.

This invention separately provides a flogger system having at least one flogger handle formed using black iron pipe and fittings.

In various exemplary embodiments of a flogger system according to this invention, the flogger system includes a flogger handle and any number of detachable flogger head. The flogger handle has a free end and a head end. The head end includes a connector portion. Each flogger head has a falls end and a handle end. The falls end of the flogger head includes at least one fall, which can be made using any number of industrial materials, including metal materials, plastic materials, leather, rubber, synthetic fibers and natural fibers. The handle end of the flogger head includes a complementary connector portion that is complementary to the connector portion of the head end of the flogger handle. The connector and complementary connector portions are detachably securely connectable. When the connector and complementary connector portions are connected together, they securely attach the flogger head to the flogger handle.

When a user wishes to change the currently-attached falls for falls of a different material or a different form of the current material, the user detaches the complementary connector portion of the currently attached flogger head from the connector portion of the flogger handle. The user typically will safely store the detached flogger head, as it may be readily and repeatedly re-attached to that flogger handle and/or to a different flogger handle. The user will then securely detachably attach a different flogger head, having falls formed using the desired different type or form of material to the original flogger handle.

In various exemplary embodiments, the connector portion comprises a male or externally-threaded head end portion of the flogger handle, while the complementary connector portion comprises a female or internally-threaded handle end portion of the flogger head, or vice-versa. In some such exemplary embodiments, the head end of the flogger handle comprises the threaded end of a threaded brass or iron pipe that forms at least a part of the flogger handle, while the handle end of the flogger head is formed in part using a threaded brass or iron coupling. In other such exemplary embodiments, the flogger handle includes a brass or iron pipe and the head end of the flogger handle comprises a threaded brass or iron nipple that is connected to that brass or iron pipe using a brass or iron coupling.

In various other exemplary embodiments, the connector and complementary connector portions are complementary parts of a two-element quick-connect fitting, a two-element twist connector or the like. In yet other exemplary embodiments, the connector and complementary connector portions comprise an unthreaded end of a copper, pvc or plastic tube and a complementary connector that is securely attachable to that unthreaded tube end.

These and other features and advantages of this invention are described in or are apparent from the following detailed description of the preferred embodiments.

### BRIEF DESCRIPTION OF THE DRAWINGS

Various exemplary embodiments of this invention will be described in detail, with reference to the following figures, wherein:

FIG. 1 is a side plan view of a first exemplary embodiment of a flogger according to this invention, comprising a flogger handle and a single detachably attached flogger head;

FIG. 2 is a side plan view of a first exemplary embodiment of a flogger handle according to this invention;

FIG. 3 is a side plan view of a first exemplary embodiment of a flogger head according to this invention, with the falls omitted;

FIGS. 4 and 5 are, respectively, a front perspective view and a front plan view of the first exemplary embodiment of the flogger head shown in FIG. 3, with the falls omitted;

FIG. 6 is a rear plan view of the first exemplary embodiment of the flogger head shown in FIG. 3;

FIG. 7 is a side plan view of a second exemplary embodiment of a flogger handle according to this invention;

FIG. 8 is a side plan view of a second exemplary embodiment of a flogger according to this invention, comprising a flogger handle and a pair of detachably attached flogger heads;

FIG. 9 is a side plan view of a third exemplary embodiment of a flogger handle according to this invention; and

FIG. 10 is a side plan view of a second exemplary embodiment of a flogger head according to this invention, with the falls omitted.

### DETAILED DESCRIPTION OF EXEMPLARY EMBODIMENTS

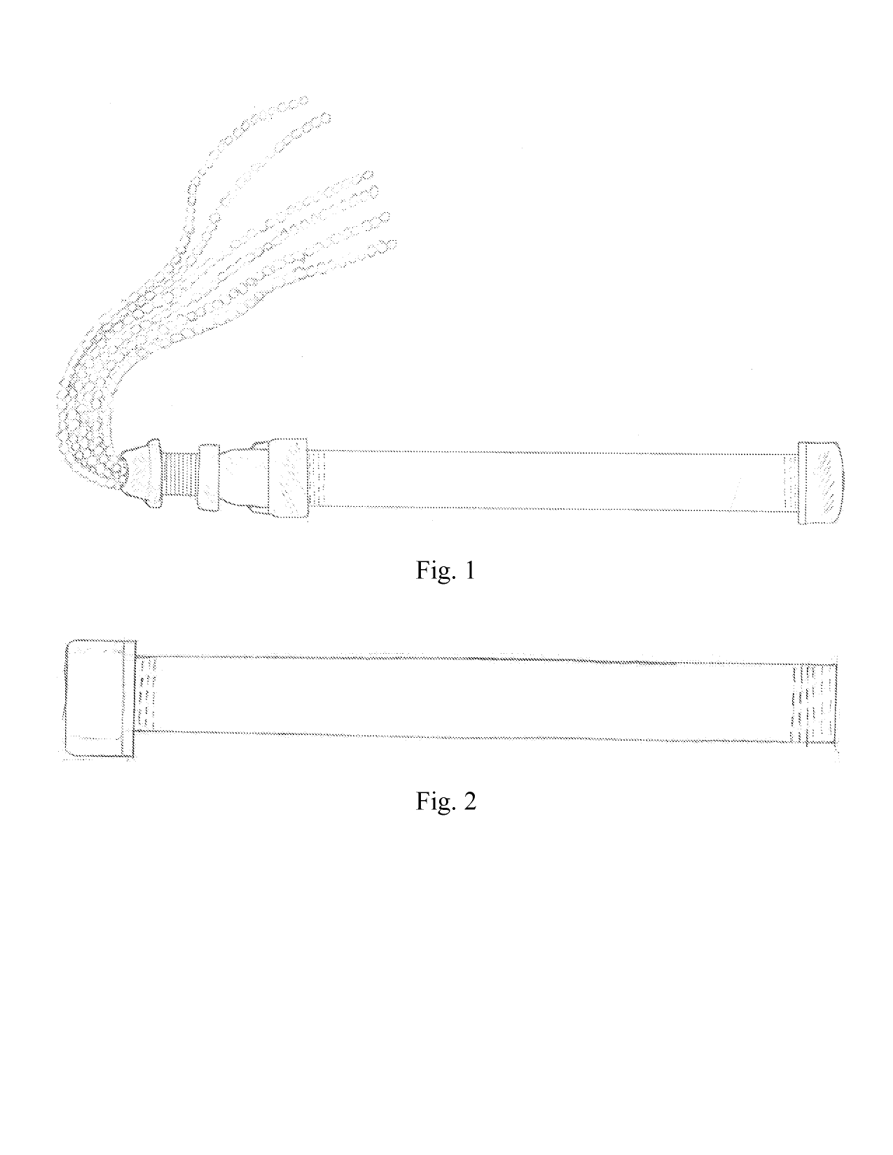

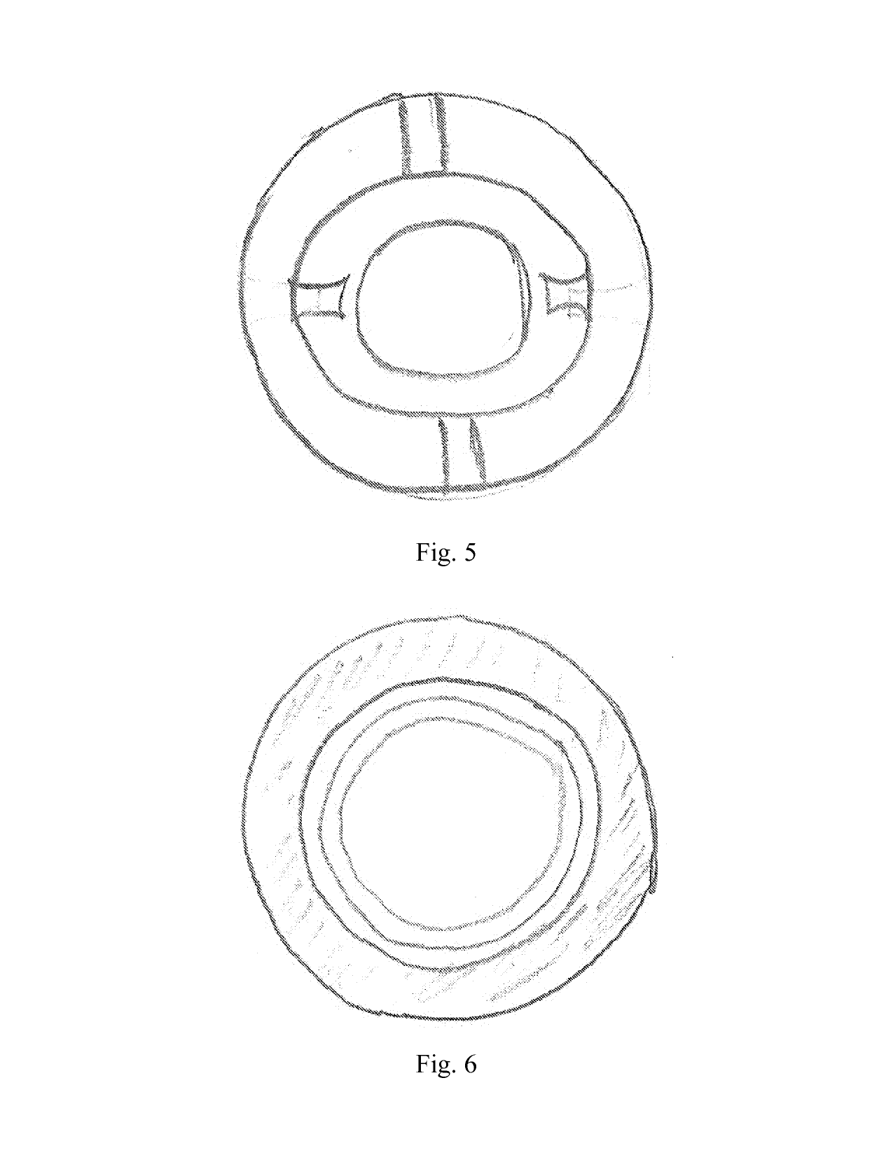

FIGS. 1-6 illustrate a first exemplary embodiment of a flogger 100 according to this invention. As shown in FIGS. 1-6, the flogger 100 includes a flogger handle 110, a detachably or removably attached flogger head 120, and one or more falls 130 that are securely mounted to the flogger head 120. As shown in FIGS. 1 and 2, the flogger handle 110 includes a handle body 112, first and second threaded ends 113 and 114, a cover 115, and an end cap 116. The second end 114 forms the connector portion 111 of the flogger handle 110. As shown in FIGS. 1 and 3-6, the flogger head comprises a falls portion 122, a body portion 124, and a connector portion 126. As shown in FIG. 6, the connector portion 126 includes a number of internal threads 127 that form the complementary connector portion 121. As shown in FIG. 1, the flogger fall(s) 130 are secured to the falls portion 122.

In various exemplary embodiments, the handle body 112 is formed using a threaded iron, brass or other metal pipe or nipple. In these exemplary embodiments, the end cap 116 is also internally threaded and screwed onto the first threaded end 113. In various other exemplary embodiments, the handle body 112 is formed using a smooth pipe or nipple that is formed of iron, brass, pvc or other appropriate metal or polymer material. In these other exemplary embodiments, the end cap 116 has a smooth internal surface and is secured to the first end 113 using solder, adhesive, solvent or other appropriate material. In various exemplary embodiments, the handle body 112 ranges in length from around 4 inches to around 12 inches and ranges in diameter from around ⅜ inch to about 1 inch. In various exemplary embodiments, a hole can be provided through the end cap 116 and a hanging loop, strap or the like can extend through the hole from the handle 110.

In the exemplary embodiment shown in FIGS. 1 and 2, the cover 113 is a leather rectangle that is stitched together to form a sleeve. The handle body 112 is inserted into the sleeve cover 113, which is held in place by friction in combination with the end cap 116, and when it is attached, the flogger head 120. In various other exemplary embodiments, the cover 113 comprises one or more layers of a polymer or natural rubber material. In some such exemplary embodiments, the cover 113 comprises two or more layers of a heat-shrinking rubber or polymer material. It should be appreciated that the cover 113 can be formed using any other known or later-developed, appropriate and/or desired material

In the exemplary embodiments that use a heat-shrink material, the heat-shrink material is formed into a sleeve having a diameter large than that of the handle body 112. After the handle body 112 is inserted into the sleeve of heat-shrink material, the handle body 112 and the heat shrink material are heated sufficiently to shrink the heat-shrink material tightly against the outer surface of the handle body 112 to form at least a first layer of the cover 113. If the cover 113 comprises one or more additional layers, the handle body 112 and the one or more layers forming the cover 113 are inserted into a second (or third, etc.) sleeve of the heat-shrink material, and then the handle body 112 and the second (or subsequent) layer of heat shrink material are heated sufficiently to shrink that second (or subsequent) layer of heat-shrink material tightly against the outer surface of the previous layer of heat shrink material to form second (or subsequent) layer of the cover 113.

In the exemplary embodiment shown in FIGS. 1 and 3-6, the falls portion 122 comprises an iron, brass or other appropriate metal cap or other internally threaded member. In various exemplary embodiments, a hole is formed in the top surface of the cap forming the falls portion 122. It should be appreciated that the diameter of this hole can be matched to the diameter of an enclosing circle that can be provided around the specific set of falls 130 that is to be secured into that falls portion 122. To secure that specific set of falls 130, one end of the set of falls 130 is inserted through the hole or other aperture in the axially outer end of the falls portion 122 and is inserted at least into the body portion 124 that is attached to that falls portion 122. That set of falls 130 is then secured into the body portion 124 and the falls portion 122 using any suitable adhesive, such as, for example, epoxy putty, liquid glue, melted solder, hot melt glue or the like.

In some exemplary embodiments where a relatively low viscosity liquid adhesive material is used, that liquid adhesive material can be injected or allowed to flow into the entire length of the body portion 124 and/or into a top space within the falls portion 122 adjacent to the hole. In this case, the liquid adhesive material can be injected or allowed to flow into that top space through the hole and past the inserted end of the falls 130. In various exemplary embodiments, to further secure the falls 130 to the falls portion 122 and/or to completely seal off the interior regions of the falls portion 122 and/or the body portion 124, the hole is substantially, and ideally completely, filled with the adhesive material. In various exemplary embodiments, after the connection portion 126 is connected to the body portion 124, additional amounts of an adhesive material can be introduced into the interior space of the connection portion adjacent to the body portion 124. This can further secure the connection portion 126 to the body portion 124 and/or can further seal off the interior region of the body portion 124.

In the exemplary embodiment shown in FIGS. 1 and 3-6, the body portion 124 comprises an iron, brass or other appropriate metal pipe or nipple that is threaded at both ends. In various exemplary embodiments, the body portion 124 is from about ½ inch to about 2 inches in length. In the exemplary embodiment shown in FIGS. 1 and 3-6, the body portion 124 is threaded along its entire length. However, it does not need to be threaded in this way. It should be appreciated that the diameter of the body portion 124 will correspond to the inner diameter of the falls portion 122. Likewise, the inner diameter of the connector portion 126 that is attached to the body portion 124 will itself correspond to the outer diameter of the body portion 124

In the exemplary embodiment shown in FIGS. 1-6, the second end 114 comprises a number of external threads 111 that form the connector portion, while the complementary connector portion 121 is formed by the internal threads 127. As shown in FIGS. 1-3, to detachably or removably attach the flogger head 120 to the flogger handle 110, a user merely mates the internal threads 127 of the connector portion 126 to the external threads 111 of the handle 110. The user then secures the flogger head 120 to the flogger handle 110 by screwing and tightening together the internal and external threads until they cannot be further screwed or tightened together. However, it should be appreciated that any known or later-developed structure that is able to securely detachably connect the connector portion 121 of the flogger head 120 to the connector portion 111 of the flogger handle can be used in place of the externally threaded connector portion 111 and the internally threaded connector portion 121.

It should be appreciated that the falls portion 122 can have any desired inner diameter that is sufficiently large that the desired number of falls of the desired material can be inserted through a hole provided in the axially outer surface of the falls portion 122, through the inner diameter of the falls portion 122 and into the interior passage of the body portion 124. Thus, for relatively thin falls 130, especially when a relatively small number of those falls 130, are to be attached to the falls portion 122, a relatively small-diameter falls portion 122 can be used.

This small-diameter falls portion 122 may have an internal diameter that is smaller than the diameter of the connection portion 114 of the flogger handle 110. In some such exemplary embodiments, the connector portion 126 comprises a reducing (or expanding, depending on point of view) coupling. This reducing coupling will have a smaller diameter end that has a diameter that corresponds to the inner diameter of the falls portion 122 and also to the falls body 124. This reducing coupling will also have a larger diameter end that has a diameter that corresponds to the outer diameter of the connection portion 114 of the flogger handle 110 body 124 and the inner diameter of the falls portion 122.

For falls 130 having a medium diameter enclosing circle, a medium-diameter falls portion 122 can be used to attach those falls 130 to the falls portion 122. Typically, but not necessarily, this medium-diameter falls portion 122 will have an internal diameter equal to the diameter of the body portion 112 of the flogger handle 110. In some such exemplary embodiments, the connector portion 126 comprises a non-reducing coupling. This non-reducing coupling has two ends of the same diameter, with this diameter corresponding both to the outer diameter of the falls body 124 and the outer diameter of the connection portion 114 of the flogger handle 110, as well as to the inner diameter of the falls portion 122. As shown in FIG. 6, the connector portion 126 includes a number of internal threads 127 that form the complementary connector portion. As shown in FIG. 1, the flogger fall(s) 130 are secured to the falls portion 122.

In contrast, for falls 130 having a relatively large diameter enclosing circle, a relatively large-diameter falls portion 122 will need to be used. This large-diameter falls portion 122 may have an internal diameter that is larger than the diameter of the connection portion 114 of the flogger handle 110. In some such exemplary embodiments, the connector portion 126 also comprises a reducing (or expanding, depending on point of view) coupling. This reducing coupling will have a larger diameter end that has a diameter that corresponds to the outer diameter of the inner diameter of the falls portion 122 and also to the falls body 124. This reducing coupling will also have a smaller diameter end that has a diameter that corresponds to the outer diameter of the connection portion 114 of the flogger handle 110.

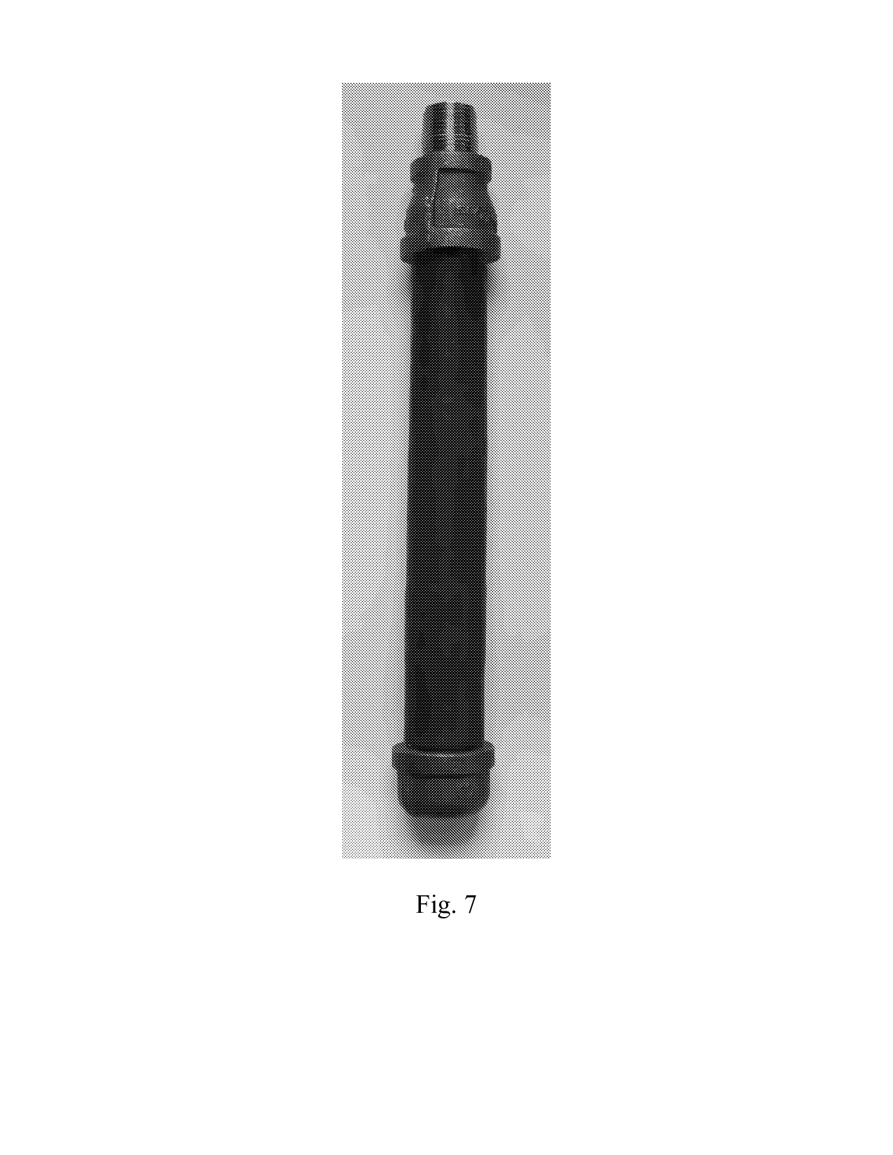

FIG. 7 shows a side plan view of a second exemplary embodiment of a flogger handle 140 according to this invention. In this second exemplary embodiment, similarly to the flogger handle 110, the flogger handle 140 includes a handle body 142, first and second threaded ends 143 and 144, a cover 145, and an end cap 146. However, in this second exemplary embodiment, the diameter of the handle body 142 is larger than the inner diameter of the connection portion 126 of the flogger head 120. Accordingly, the flogger handle 140 also includes a reducing coupling 147 attached to the second threaded end 144 and a second threaded connector 148 that has one end attached to the reducing coupling 147 and a second threaded end 149 that forms the connector portion 141 of the flogger handle 140. It should be appreciated that, except as described above, the above-outlined features and operation of the flogger handle 120 apply equally to the flogger handle 140. That description will thus not be repeated here with respect to the flogger handle 140

As with the first exemplary embodiment of the flogger handle 120, the user then secures the flogger head 120 to the flogger handle 140 by screwing and tightening together the internal and external threads of the connection portions 121 and 141 until they cannot be further screwed or tightened together. However, it should be appreciated that any known or later-developed structure that is able to securely detachably connect the connector portion 121 of the flogger head 120 to the connector portion 141 of the flogger handle 140 can be used in place of the externally threaded connector portion 141 and the internally threaded connector portion 121.

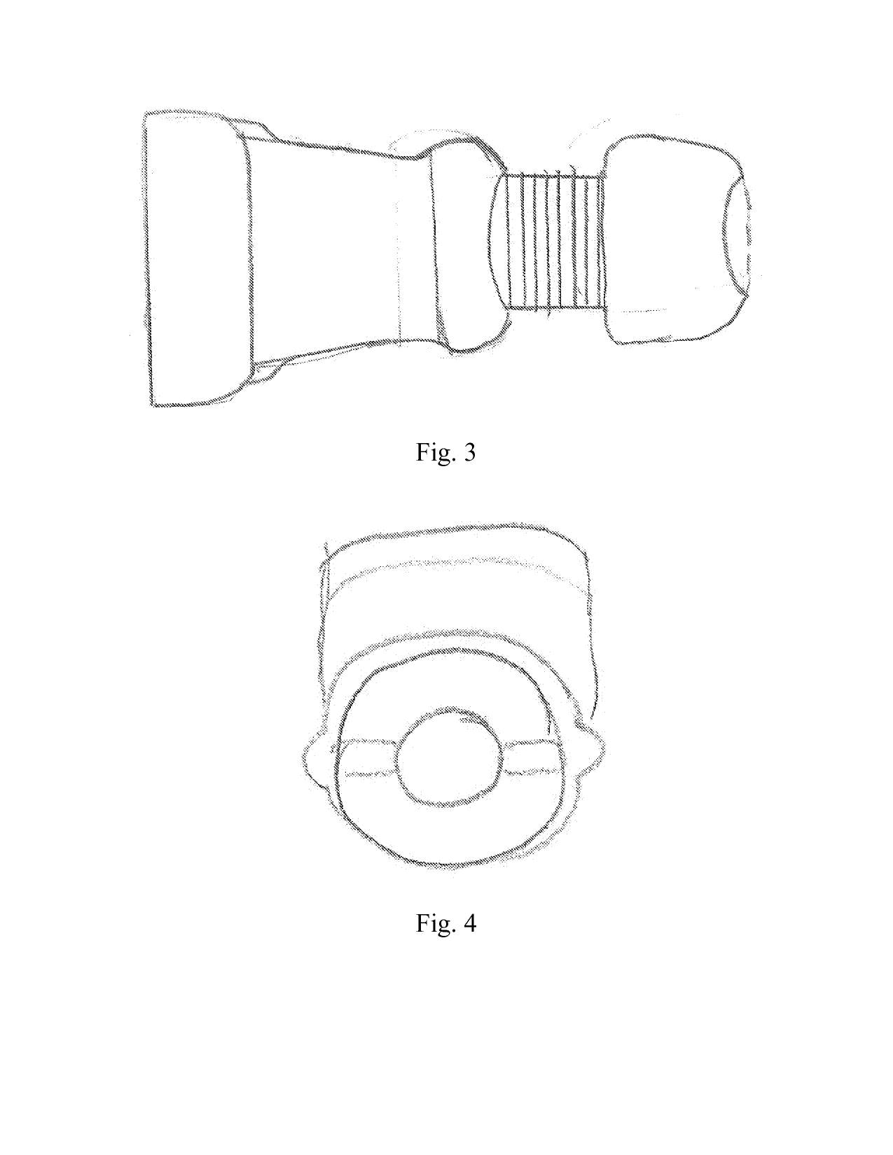

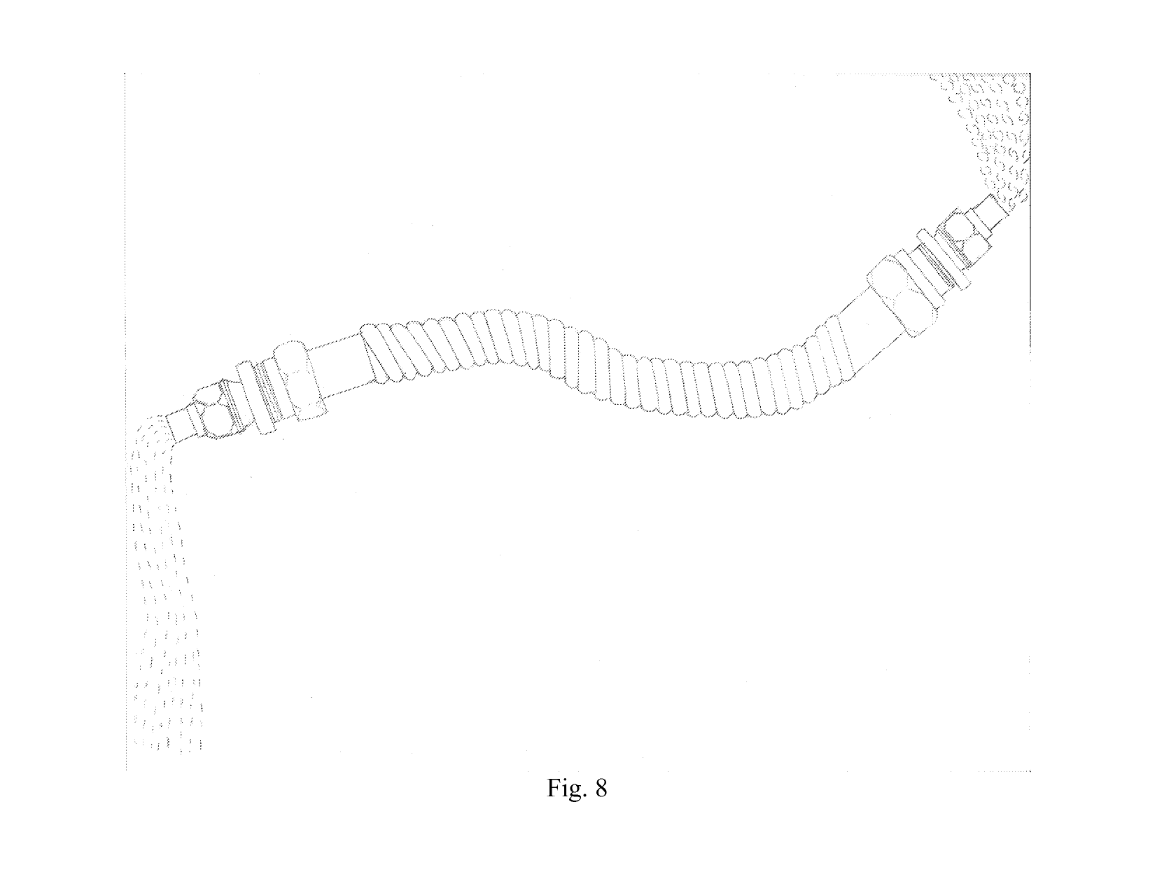

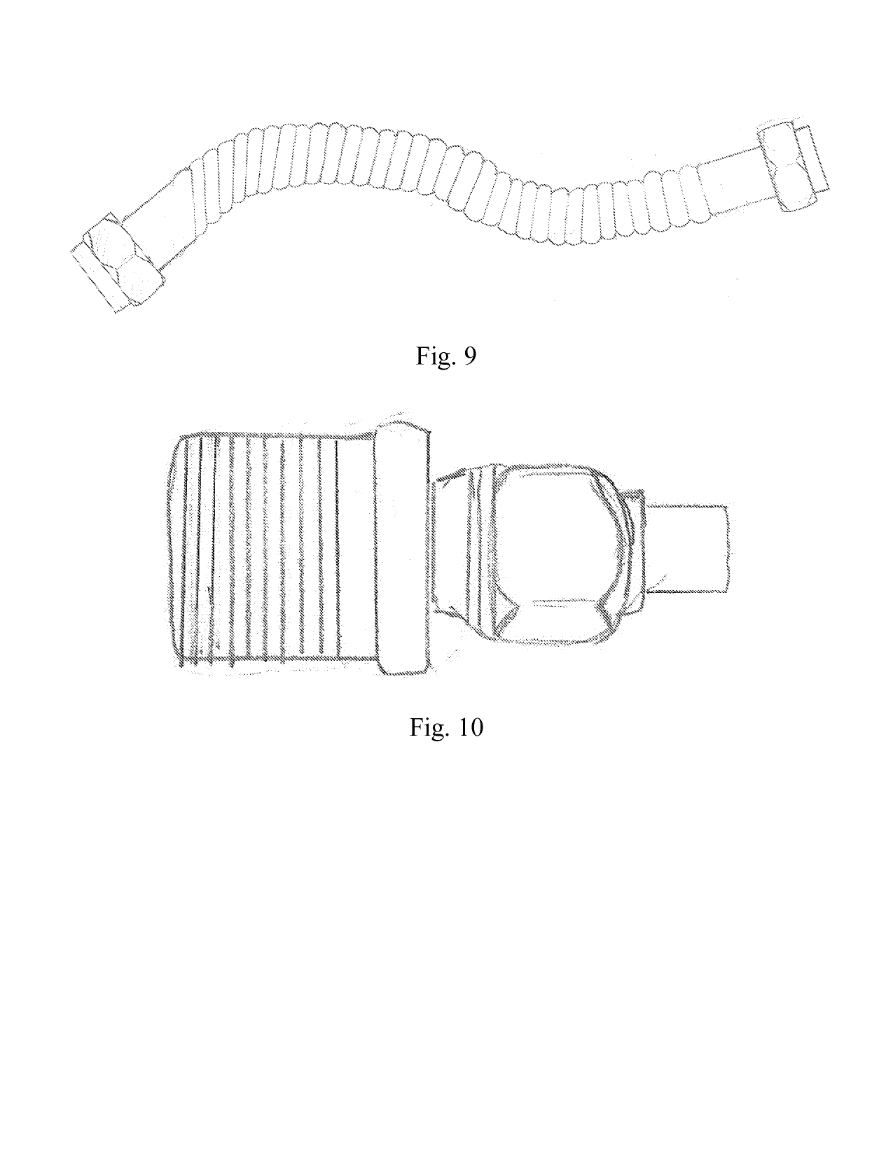

FIGS. 8-10 respectively illustrate a second exemplary embodiment of a flogger 200, a second exemplary embodiment of a flogger handle 210 and a second exemplary embodiment of a flogger head 220 according to this invention. As shown in FIGS. 8-10, the flogger 200 includes the flogger handle 210, a pair of the detachably or removably attached flogger heads 220, and two sets of falls 230, with each set of falls 230 comprising one or more falls and each set of falls 230 being securely mounted to a corresponding one of the two flogger heads 220. As shown in FIGS. 8 and 9, the flogger handle 210 includes a handle body 212, first and second threaded ends 214 and 216 and a cover 215. Each of the first and second ends 214 and 216 forms a separate connector portion 111 of the flogger handle 110. As shown in FIGS. 8 and 10, each flogger head 220 comprises a falls portion 222, a body portion 224, and a connector portion 226. As in the first exemplary flogger head 120 shown in FIGS. 3-6, in the second exemplary embodiment of the flogger head 220 shown in FIG. 10, the connector portion 226 includes a number of threads 227 that form the complementary connector portion 121. As shown in FIG. 1, the flogger fall(s) 130 are secured to the falls portion 122.

As in the first exemplary flogger head 120 shown in FIGS. 3-6, in the second exemplary embodiment of the flogger head 220 shown in FIG. 10, the connector portion 226 includes a number of internal threads 227 that form the complementary connector portion 121. As shown in FIG. 1, the flogger fall(s) 130 are secured to the falls portion 122. However, the second exemplary embodiments of the flogger handle 210 and the flogger heads 220 differ from the flogger handle 110 and the flogger head 120 in that the first and second ends 214 and 216 of the flogger handle 210 are internally threaded, while the threads 227 are formed on the outer surface of the connection portion 226. It should be appreciated that, except for these differences, the above-outlined description of the first exemplary embodiment of the flogger 100 applies equally to this second exemplary embodiment of the flogger 200.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A flogger, comprising:
a flogger handle, comprising:
a handle body having a free end and a head end,
a cover provided around the handle body between the free end and the head end,
a cap attached to the free end, and
a connection portion provided on the free end; and
a detachable flogger head, comprising:
a body portion having a first end and a second end,
a falls portion attached to the first end of the body portion,
a set of at least one fall secured into the falls portion, and
a complementary connection portion attached to the second end of the body portion;
wherein the complementary connection portion of the detachable flogger head is freely attachable, detachable and re-attachable from the connection portion of the flogger handle

2. A flogger system, comprising:
the flogger of claim 1; and
at least one of:
at least one additional detachable flogger head, and
at least one additional flogger handle; wherein:
the detachable flogger head and the at least one additional detachable flogger head are freely attachable, detachable and re-attachable from the connection portion of the flogger handle; and
the flogger handle and the at least one additional flogger handle are freely attachable, detachable and re-attachable to the complementary connection portion of the detachable flogger head.

3. A flogger handle, comprising:
a handle body having a free end and a head end;
a cover provided around the handle body between the free end and the head end;
a cap attached to the free end; and
a connection portion provided on the free end.

4. A detachable flogger head, comprising:
a body portion having a first end and a second end;
a falls portion attached to the first end of the body portion;
a set of at least one fall secured into the falls portion; and
a complementary connection portion attached to the second end of the body portion.
